(19) United States
(12) Patent Application Publication
(10) Pub. No.: US 2024/0310771 A1
(43) Pub. Date: Sep. 19, 2024

(54) SLIDE RAIL AND IMAGE FORMING APPARATUS

(71) Applicant: KYOCERA Document Solutions Inc., Osaka (JP)

(72) Inventor: Akira ISHII, Osaka (JP)

(73) Assignee: KYOCERA Document Solutions Inc., Osaka (JP)

(21) Appl. No.: 18/603,074

(22) Filed: Mar. 12, 2024

(30) Foreign Application Priority Data
Mar. 14, 2023 (JP) 2023-039853

(51) Int. Cl. G03G 15/00; B41J 13/10; G03G 21/16

(52) U.S. Cl. CPC G03G 15/6502; B41J 13/103; G03G 21/1619; G03G 21/1623; G03G 2221/1684

(57) ABSTRACT

The slide rail includes an outer rail, an inner rail and a drawing mechanism. The outer rail is fixed on an inner surface of a housing. The inner rail is fixed to a unit, engaged with the outer rail and moves along the outer rail. The drawing mechanism is supported by the outer rail, coupled to the inner rail at a draw-in start position and draws in the inner rail to a draw-in end position along a draw-in direction. The inner rail includes a coupling pin and a protrusion. The coupling pin is provided on one end portion in the draw-in direction, and configured to be engaged with the drawing mechanism. The protrusion is provided on the other end portion in the draw-in direction, and protrudes toward the outer rail.

### INCORPORATION BY REFERENCE

This application is based on and claims the benefit of priority from Japanese patent application No. 2023-039853 filed on Mar. 14, 2023 which is incorporated by reference in its entirety.

### BACKGROUND

The present disclosure relates to an image forming apparatus including a slide rail which supports a sheet feeding device in a housing in a drawable manner.

In the image forming apparatus, a sheet feeding cassette is supported by a cassette housing part of a housing via a slide rail. The slide rail is provided with an outer rail fixed to the inner surface of the cassette housing part, an inner rail fixed to the sheet feeding cassette, engaged with the outer rail and slid along the outer rail, and a drawing mechanism supported by the outer rail, engaged with the inner rail at a draw-in start position, and drawing in the inner rail to a draw-in end position. The draw-in end position is a sheet feeding position where the sheet stored in the sheet feeding cassette can be fed by the sheet feeding device.

The slide rail may be configured such that a coupling pin is provided at the downstream end portion of the inner rail in the draw-in direction, and the coupling pin is coupled to the drawing mechanism at the draw-in start position so that the inner rail is drawing in to the draw-in end position.

In the slide rail described above, the pin coupled to the draw-in mechanism is provided at the downstream end portion (rear end portion) of the inner rail in the draw-in direction (the front-and-rear direction, inner rail length direction). A plurality of balls is disposed between the inner rail and the outer rail to smoothly guide the slide of the inner rail relative to the outer rail. In many cases, such a ball is mainly disposed in the center portion in the length direction of the inner rail.

With such a configuration, the rattling of the inner rail with respect to the outer rail may increase at the upstream end portion (front end portion) of the inner rail in the draw-in direction. If the inner rail is rattled, there is a possibility that a coupling failure between the coupling pin and the draw-in mechanism occurs, and the draw-in mechanism prevents the sheet feeding cassette from being drawn in to the sheet feed position. In this case, a sheet feeding failure occurs in which the sheet is not properly fed from the sheet feeding cassette by the sheet feeding device.

### SUMMARY

A slide rail according to the present disclosure supports a unit on an inner surface of a housing. The slide rail includes an outer rail, an inner rail and a drawing mechanism. The outer rail is fixed on the inner surface of the housing. The inner rail is fixed to the unit, engaged with the outer rail and moves along the outer rail. The drawing mechanism is supported by the outer rail, coupled to the inner rail at a draw-in start position and draws in the inner rail to a draw-in end position along a draw-in direction. The inner rail includes a coupling pin and a protrusion. The coupling pin is provided on one end portion in the draw-in direction, and configured to be engaged with the drawing mechanism. The protrusion is provided on the other end portion in the draw-in direction, and protrudes toward the outer rail.

An image forming apparatus according to the present disclosure includes the slide rail. The unit is a sheet feeding cassette in which a sheet on which an image is to be formed is stored, and the draw-in end position is a sheet feeding position where the sheet can be fed from the sheet feeding cassette to an image forming part.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an image forming apparatus according to one embodiment of the present disclosure.

FIG. 2 is a front view schematically showing a cassette housing part of the image forming apparatus according to the embodiment of the present disclosure.

FIG. 3 is a perspective view showing a slide rail according to the embodiment of the present disclosure.

FIG. 4 is a cross-sectional view showing the slide rail according to the embodiment of the present disclosure.

FIG. 5A is a perspective view showing an inner rail of the slide rail according to the embodiment of the present disclosure.

FIG. 5B is a perspective view showing the front end portion of the inner rail of the slide rail according to the embodiment of the present disclosure.

FIG. 6A is a side view showing a draw-in mechanism (a state in which a coupling member is turned to a holding posture) of the slide rail according to the embodiment of the present disclosure.

FIG. 6B is a perspective view showing a coupling plate of the slide rail of the draw-in mechanism according to the embodiment of the present disclosure.

FIG. 7A is a diagram explaining the operation of the draw-in mechanism when the sheet feeding cassette is drawn in (in a state where the coupling pin enters a hook of the coupling), in the slide rail according to the embodiment of the present disclosure.

FIG. 7B is a diagram explaining the operation of the draw-in mechanism when the sheet feeding cassette is drawn in (in a state where the coupling pin is turned to a releasing position), in the slide rail according to the embodiment of the present disclosure.

FIG. 7C is a diagram explaining the operation of the draw-in mechanism when the sheet feeding cassette is drawn in (in a state where a slider is being drawn in), in the slide rail according to the embodiment of the present disclosure.

FIG. 8 is a view showing a front end portion of an intermediate rail according to another embodiment of the slide rail according to the embodiment of the present disclosure.

### DETAILED DESCRIPTION

Hereinafter, with reference to the attached drawings, a slide rail and an image forming apparatus according to one embodiment of the present disclosure will be described.

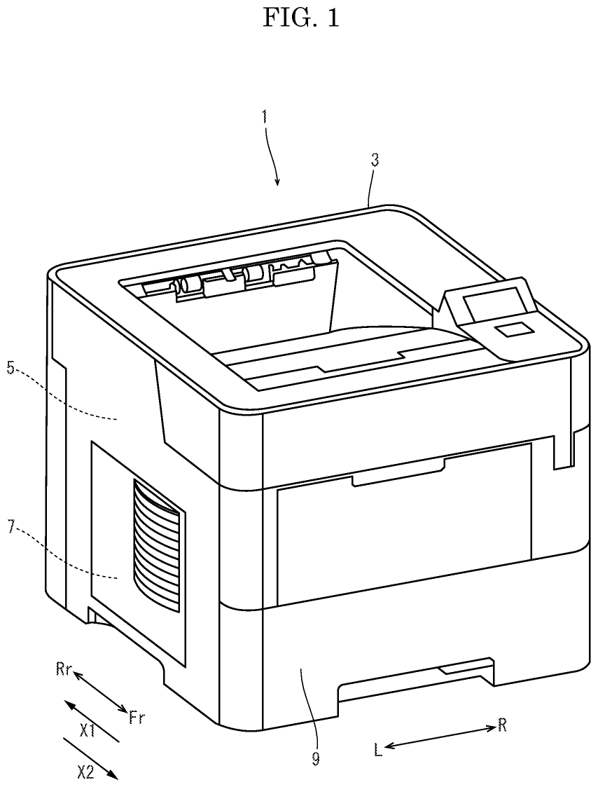

First, with reference to FIG. 1, the image forming apparatus 1 will be described with reference to FIG. 1. FIG. 1 is a perspective view showing the image forming apparatus 1. In each figure, Fr, Rr, L, and R indicate the front side, rear side, left side, and right side of the image forming apparatus 1.

The image forming apparatus 1 includes a housing 3 having an internal space of a substantially rectangular parallelepiped shape. In the upper portion of the inner space of the housing 3, an image forming part 5 which forms an image on a sheet is provided. In the lower portion of the inner space of the housing 3, a cassette housing part 7 is provided. In the cassette housing part 7, a sheet feeding cassette 9 which stores the sheet, and a sheet feeding device (not shown) which feeds the sheet from the sheet feeding cassette 9 toward the image forming part 5 are housed. The sheet feeding cassette 9 is an example of the unit in the present disclosure.

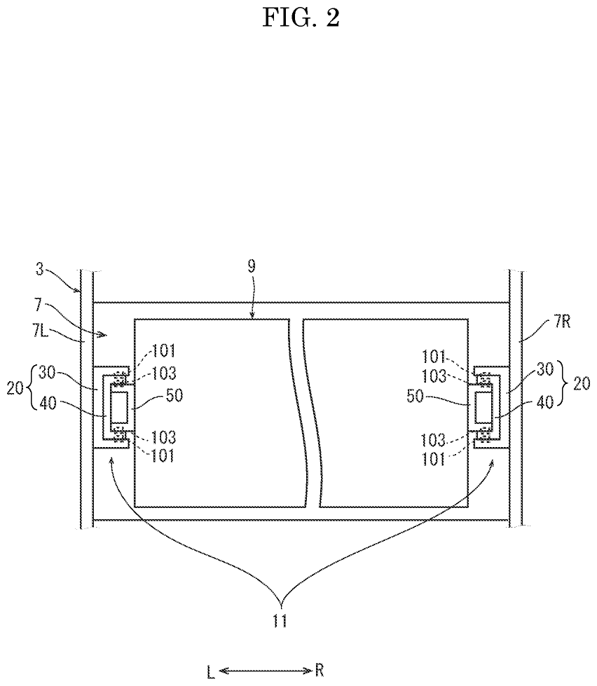

The sheet feeding cassette 9 is supported by a slide rail 11 (to be described later with reference to FIG. 2 and the others), and can be moved between a sheet feeding position housed in the cassette housing part 7 and a draw-out position drawn out forward from the cassette housing part 7 along the front-and-rear direction along the horizontal direction. When the sheet feeding cassette 9 is housed in the cassette housing part 7 and moved to the sheet feeding position, the sheet can be fed from the sheet feeding cassette 9 to the image forming part 5 by the sheet feeding device. The direction from the draw-out position to the sheet feeding position (the direction from the front side to the rear side) is set to the draw-in direction X1 of the sheet feeding cassette 9, and the direction from the sheet feeding position to the draw-out position (the direction from the rear side to the front side) is set to the draw-out direction X2 of the sheet feeding cassette 9. The sheet feeding cassette 9 can be completely drawn out from the housing 3.

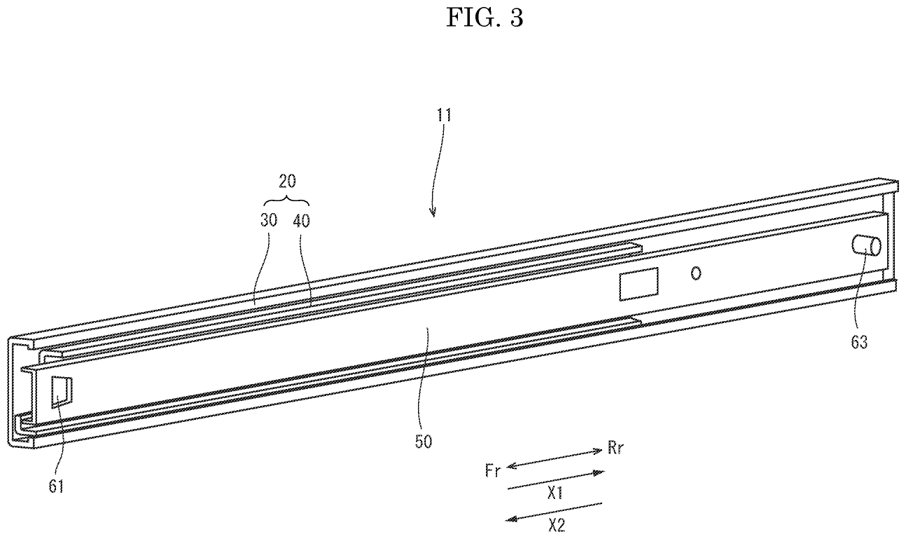

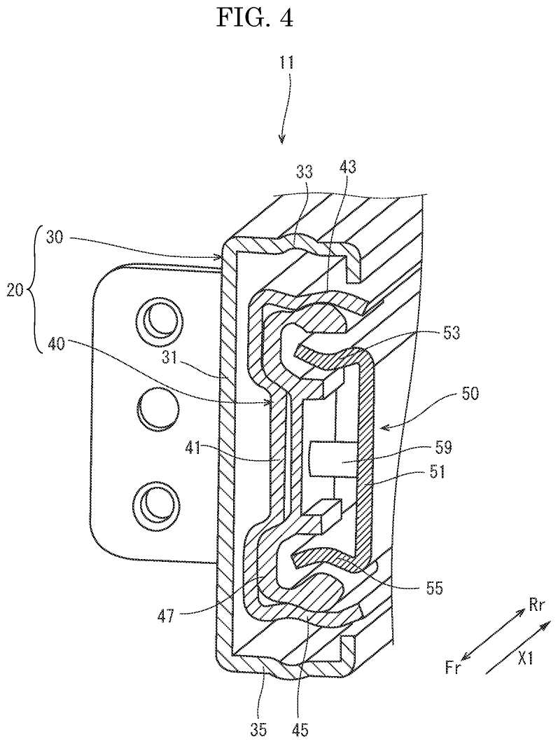

Next, the slide rail 11 will be described with reference to FIG. 2 to FIG. 4. FIG. 2 is a front view schematically showing the cassette housing part 7, FIG. 3 is a perspective view schematically showing the slide rail 11, and FIG. 4 is a cross-sectional perspective view showing the slide rail 11.

As shown in FIG. 2, the slide rail 11 includes a pair of left and right outer rails 20 fixed to the left and right side plates 7L, 7R of the cassette housing part 7, and a pair of left and right inner rails 50 fixed to the left and right side surfaces of the sheet feeding cassette 9 and moving along the outer rails 20 while engaging with the outer rails 20. The outer rail 20 has a pair of left and right fixed rails 30 fixed to the left and right side plates 7L, 7R, and a pair of left and right intermediate rails 40 engaged with the fixed rails 30 and moved along the fixed rails 30. The inner rail 50 is engaged with the intermediate rail 40 and moved along the intermediate rail 40. Each rail is made of metal or resin.

As shown in FIG. 3 and FIG. 4, the fixed rail 30 has a base portion 31 elongated in the front-and-rear direction, an upper edge portion 33 bent at a substantially right angle from the upper end of the base portion 31, and a lower edge portion 35 bent at a substantially right angle from the lower end of the base portion 31, and is formed to have a U-shaped cross section. The base portions 31 of the left and right fixed rails 30 are fixed to the left and right side plates 7L, 7R of the cassette housing part 7 in parallel along the front-and-rear direction in a posture in which the openings between the upper and lower edge portions 33, 35 face the inside of the cassette housing part 7.

The intermediate rail 40 has a length shorter than the fixed rail 30, has a base portion 41, an upper edge portion 43 bent at a substantially right angle from the upper end of the base portion 41, and a lower edge portion 45 bent at a substantially right angle from the lower end of the base portion 41, and is formed to have a U-shaped cross section. An auxiliary rail 47 is fixed to both the longitudinal end portions of the intermediate rail 40. The auxiliary rail 47 has a cross section similar to that of the intermediate rail 40, and is fixed to the inner surface of both the end portions of the intermediate rail 40.

The intermediate rail 40 is movably supported along the fixed rail 30 in a space surrounded by the base portion 31, the upper edge portion 33 and the lower edge portion 35 of the fixed rail 30 in a posture in which the opening between the upper and lower edge portions 43, 45 faces the inside of the cassette housing part 7. A plurality of balls 101 (see FIG. 2) connected by a retainer (not shown) is rotatably arranged between the upper edge portion 33 of the fixed rail 30 and the upper edge portion 43 of the intermediate rail 40, and between the lower edge portion 35 of the fixed rail 30 and the lower edge portion 45 of the intermediate rail 40. The plurality of balls 101 is mainly arranged in the center portion of both the rails in the length direction. These balls 101 allow the intermediate rail 40 to be moved smoothly relative to the fixed rail 30.

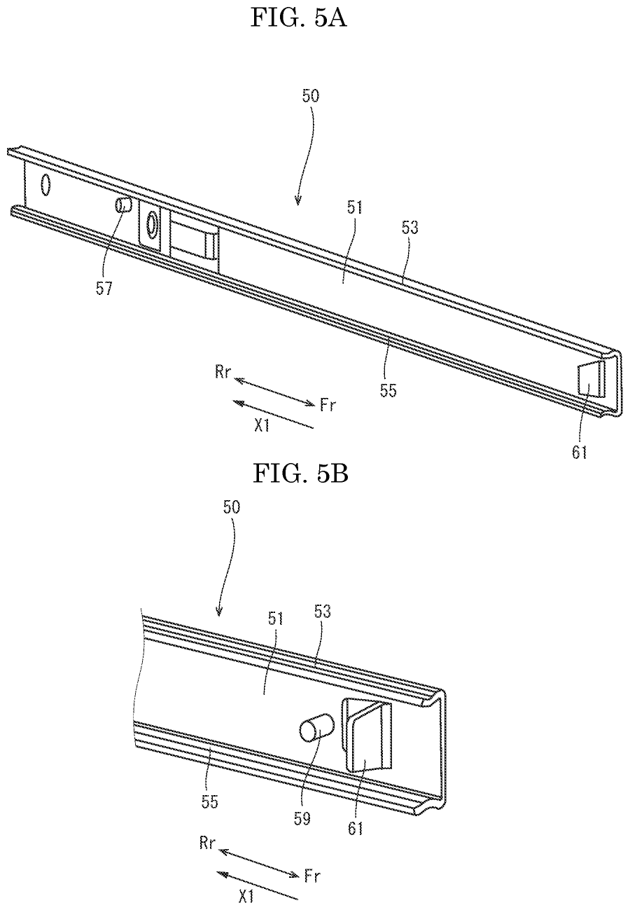

Next, the inner rail 50 will be described with reference to FIG. 5A and FIG. 5B. FIG. 5A is a perspective view showing the inner rail 50, and FIG. 5B is a perspective view showing the front end portion of the inner rail 50. The inner rail 50 has a length equivalent to that of the fixed rail 30, has a base portion 51, an upper edge portion 53 bent at a substantially right angle from the upper end of the base portion 51, and a lower edge portion 55 bent at a substantially right angle from the lower end of the base portion 51, and is formed to have a U-shaped cross section. As shown in FIG. 5A, a coupling pin 57 is protruded on one end portion of the inner surface of the base portion 51 (the downstream side end portion in the draw-in direction X1, the rear end portion).

As shown in FIG. 5B, a cylindrical pin 59 and a cut-out piece 61 formed by cutting the base portion 51 into a trapezoidal shape are provided on the other end portion of the inner surface of the base portion 51 (the upstream side end portion in the draw-in direction X1, the front end portion). The cut-out piece 61 is arranged outside the pin 59 in the longitudinal direction, and is cut up along the edge along the upper-and-lower direction toward the other end portion (the front end portion) at a substantially right angle. The pin 59 and the cut-out piece 61 are examples of the protrusion protruding toward the outer rail 20 in the present disclosure. As shown in FIG. 3, a pin 63 coupled to the sheet feeding cassette 9 is protruded on the other end portion of the outer surface of the base portion 51 (the downstream side end portion, the rear portion).

The inner rail 50 is movably supported along the intermediate rail 40 in a space surrounded by the base portion 41, the upper edge portion 43, and the lower edge portion 45 of the intermediate rail 40 in a posture in which the opening between the upper and lower edge portion 53, 55 faces the outside of the cassette housing part 7 (the side of the intermediate rail 40), and the coupling pin 57 is positioned on the downstream side in the draw-in direction X1 (the rear side) while the pin 59 and the cut-out piece 61 are positioned on the upstream side in the draw-in direction (the front side). A plurality of balls 103 (see FIG. 2) connected by a retainer (not shown) is rotatably arranged between the upper edge portion 43 of the intermediate rail 40 and the upper edge portion 53 of the inner rail 50, and between the lower edge portion 45 of the intermediate rail 40 and the lower edge portion 55 of the inner rail 50. The plurality of balls 103 is mainly arranged in the center portion of both the rails in the length direction. These balls 103 allow the inner rail 50 to be moved smoothly relative to the intermediate rail 40.

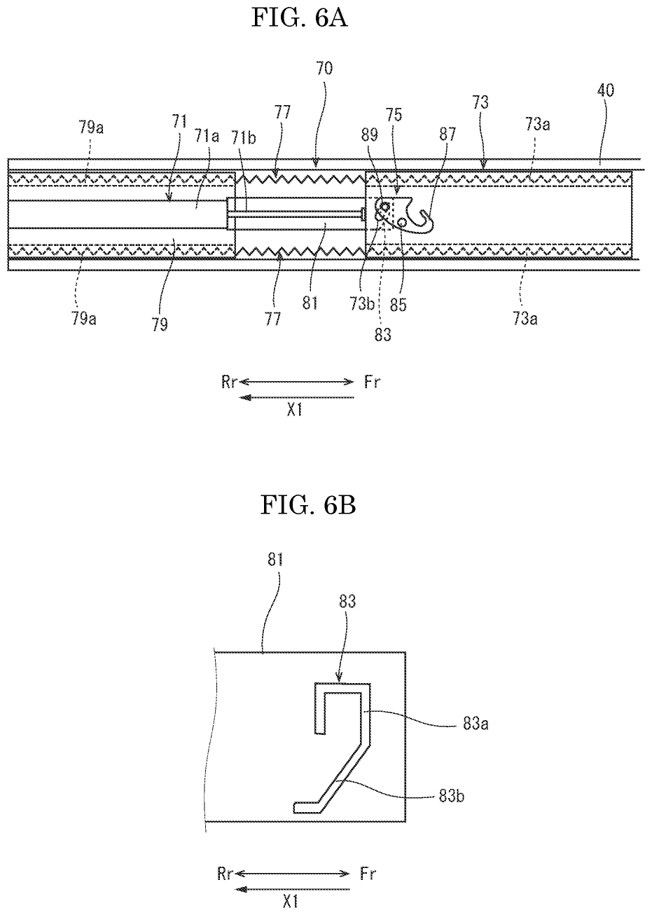

A drawing mechanism 70 (see FIG. 6A and the others) is arranged between the inner rail 50 and the intermediate rail 40. The drawing mechanism 70 is provided on the intermediate rail 40, engaged with the inner rail 50 when the sheet feeding cassette 9 is moved to the draw-in start position near the sheet feeding position, and automatically draws in the sheet feeding cassette 9 to the sheet feed position (the draw-in end position).

Next, the drawing mechanism 70 will be described with reference to FIG. 6A and FIG. 6B. FIG. 6A is a view showing the drawing mechanism 70, and FIG. 6B is a perspective view showing a guide rib 83. As shown in FIG. 6A, the drawing mechanism 70 includes a damper 71 for damping the impact generated when the sheet feeding cassette 9 is drawn in, a slider 73 connected to the damper 71, a coupling member 75 supported by the slider 73 and capable of being coupled to the coupling pin 57 of the inner rail 50, and a pair of coil springs 77 for drawing in the inner rail 50. In the following description of the drawing mechanism 70, the side facing the cassette housing part 7 is referred to as the inner side, and the side opposite to the cassette housing part 7 is referred to as the outer side.

The damper 71 has a main body 71a and a plunger 71b drawn into the main body 71a, and is supported by a damper holder 79. The damper holder 79 is fixed on the downstream end portion (the rear end portion) of the inner surface of the base portion 41 of the intermediate rail 40 in the draw-in direction X1. The main body 71a of the damper 71 is fixed to the damper holder 79 in a posture in which the plunger 71b faces the upstream side (the front side) of the draw-in direction X1. The plunger 71b slightly floats from the inner surface of the damper holder 79. A spring housing portion 79a is formed along the upper and lower end portions of the damper holder 79.

A coupling plate 81 is fixed on the inner surface of the base portion 31 of the fixed rail 30 on the upstream side of the damper holder 79 in the draw-in direction X1. The coupling plate 81 may be integrally provided with the damper holder 79. A guide rib 83 for guiding a boss 89 of the coupling member 75, which will be described later, is formed at the upstream end portion (the front end portion) of the coupling plate 81 in the draw-in direction X1. As shown in FIG. 6B, the guide rib 83 has an accommodating portion 83a for restricting the movement of the boss 89 in the draw-in direction X1, and an inclined portion 83b for guiding the boss 89 to the accommodating portion 83a. The accommodating portion 83a is formed along a direction intersecting the draw-in direction X1. The inclined portion 83b is formed so as to incline toward the accommodating portion 83a from the downstream side to the upstream side of the draw-in direction X1.

With reference to FIG. 6 again, the slider 73 is fixed to the tip of the plunger 71b of the damper 71, and movably supported along the fixed rail 30. A spring housing portion 73a is formed along the upper and lower end portions of the slider 73.

The coupling member 75 is a member that is coupled to the coupling pin 57 of the inner rail 50 when the inner rail 50 is moved to a predetermined position. The coupling member 75 is supported on the inner surface of the slider 73 in a turnable manner around the rotational shaft 85. The coupling member 75 has a hook 87 and a boss 89. The hook 87 is provided on the upstream side of the rotational shaft 85 in the draw-in direction X1, and can be coupled to the coupling pin 57. The boss 89 is protruded from the outer surface on the downstream side of the rotational shaft 85 in the draw-in direction X1. The slider 73 has a groove hole 73b into which the boss 89 is inserted and guides the boss 89 when the coupling member 75 is turned. The boss 89 passes through the groove hole 73b, and the tip portion protrudes from the groove hole 73b. The protruding tip portion is guided along the guide rib 83 provided on the coupling plate 81 described above.

The coupling member 75 can be turned to a holding posture in which the tip portion of the boss 89 is accommodated in the accommodating portion 83a of the guide rib 83 and to a releasing posture in which the tip portion of the boss 89 is separated from the accommodating portion 83a of the guide rib 83. In the holding posture, the movement of the boss 89 in the draw-in direction X1, that is, the movement of the slider 73 is restricted, and in the releasing posture, the movement restriction of the boss 89 in the draw-in direction X1, that is, the movement restriction of the slider 73 is released. In the holding posture, the opening of the hook 87 faces the upstream side of the draw-in direction X1.

The pair of coil springs 77 are housed in the spring housing portions 79a of the damper holder 79 and the spring housing portions 73a of the slider 73. One ends of the coil springs 77 are fixed to the downstream end portions of the spring housing portions 79a of the damper holder 79 in the draw-in direction X1, and the other end is fixed to the upstream end portions of the spring housing portions 73a of the slider 73 in the draw-in direction X1. The pair of coil springs 77 biases the slider 73 toward the damper 71, that is, toward the downstream side in the draw-in direction X1.

As described above, the slider 73 is biased by the coil springs 77 from the draw-in start position where the slider 73 is separated from the damper holder 79 to the upstream side in the draw-in direction X1 and the boss 89 is accommodated in the accommodating portion 83a of the guide rib 83 to the draw-in end position where the slider 73 abuts on the damper holder 79.

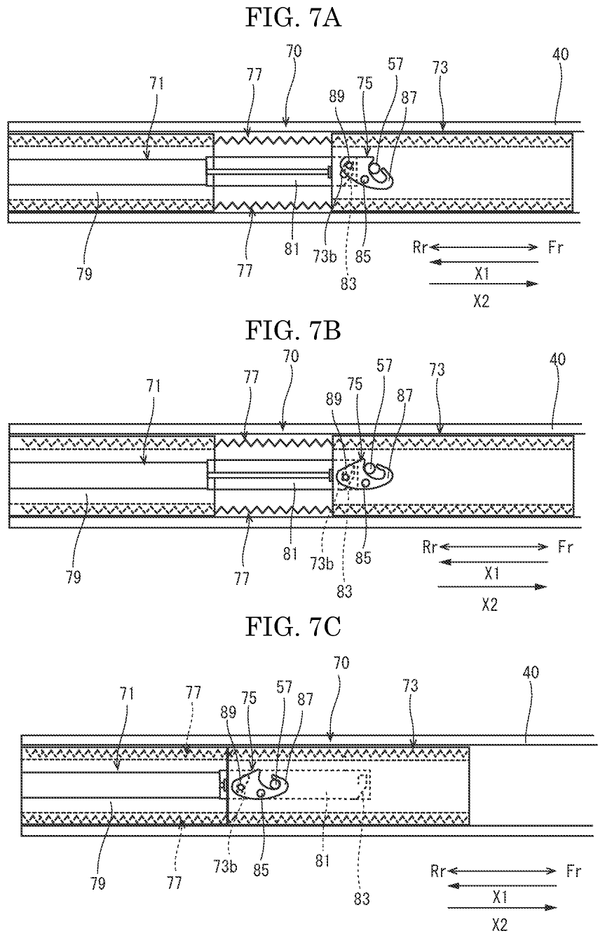

The drawing operation of the sheet feeding cassette 9 in the slide rail 11 having the above configuration will be described with reference to FIG. 7A to FIG. 7C. The slide rail 11 is extended and retracted to a retracting state where the intermediate rail 40 is accommodated in the fixed rail 30 and the inner rail 50 is accommodated in the intermediate rail 40, and to an extending state where the intermediate rail 40 is drawn out from the fixed rail 30 and the inner rail 50 is drawn out from the intermediate rail 40. Since the outer rail 20 is provided with the fixed rail 30 and the intermediate rail 40, the drawing length of the inner rail 50 can be increased.

In the extending state of the slide rail 11, the slider 73 of the drawing mechanism 70 is moved to the draw-in start position.

When the sheet feeding cassette 9 is inserted into the cassette housing part 7 and the inner rail 50 is moved along the intermediate rail 40 in the draw-in direction X1, the coupling pin 57 of the inner rail 50 (not shown) enters the hook 87 of the coupling member 75 through the opening of the hook 87, as shown in FIG. 7A.

Further, as shown in FIG. 7B, the coupling pin 57 pushes the hook 87 in the draw-in direction X1, and the coupling member 75 is turned from the holding posture to the releasing posture. As a result, the hook 87 is surely hooked to the coupling pin 57. Thus, the coupling member 75 and the inner rail 50, that is, the slider 73 and the sheet feeding cassette 9 are surely coupled at the draw-in start position. Further, when the coupling member 75 is turned to the releasing posture, as shown in FIG. 7C, the boss 89 is separated from the accommodating portion 83a (see FIG. 6B) of the guide rib 83, and the restriction of the movement of the slider 73 by the guide rib 83 is released. Then, the slider 73 is biased in the draw-in direction X1 by the coil springs 77, and is drawn in to the draw-in end position. That is, the sheet feeding cassette 9 is drawn in to the sheet feeding position. At this time, the sheet feeding cassette 9 is slowly drawn in by the action of the damper 71.

On the other hand, when the sheet feeding cassette 9 is drawn out from the cassette housing part 7, the slider 73 is moved in the draw-out direction X2 against the biasing force of the coil springs 77. When the boss 89 of the coupling member 75 supported by the slider 73 abuts against the inclined portion 83b (see FIG. 6B) of the guide rib 83, the boss 89 is guided to the accommodating portion 83a along the inclined portion 83b. With the movement of the boss 89, the coupling member 75 is turned from the releasing posture to the holding position. When the boss 89 is fully accommodated in the accommodating portion 83a, the coupling member 75 is completely turned to the holding posture. Then, the coupling pin 57 of the inner rail 50 gets out from the hook 87 of the coupling member 75 through the opening of the hook 87, and the coupling between the coupling member 75 and the inner rail 50, that is, the coupling between the slider 73 and the sheet feeding cassette 9 is released.

As described above, in the slide rail 11 of the present disclosure, the coupling pin 57 of the inner rail 50 provided in the downstream end portion (the rear end portion) in the draw-in direction X1 is engaged with the drawing mechanism 70 provided in the fixed rail 30. Further, the plurality of balls 101 for smoothly moving the inner rail 50 with respect to the intermediate rail 40 and the plurality of balls 103 for smoothly moving the intermediate rail 40 with respect to the fixed rail 30 are mainly disposed in the center portion of each rail in the length direction. Therefore, the upstream end portion (the front end portion) of the inner rail 50 in the draw-in direction X1 is relatively free to be displaced in the left-and-right direction, that is, in the direction closer to or separated from the intermediate rail 40. For example, if the upstream end portion is displaced so as to be close to the fixed rail 30, the downstream end portion may be moved away from the fixed rail 30, causing the coupling pin 57 of the inner rail 50 to be separated away from the coupling member 75 of the drawing mechanism 70 supported by the fixed rail 30, or the coupling pin 57 may not be engaged with the drawing mechanism 70 normally. Then, the drawing mechanism 70 does not operate normally, making it impossible to reliably draw in the sheet feeding cassette 9 to the sheet feeding position, and there is a possibility that the sheet feeding failure occurs.

In the slide rail 11 of the present disclosure, since the pin 59 protruding toward the intermediate rail 40 is provided in the upstream end portion of the inner rail 50 in the draw-in direction X1, when the inner rail 50 is displaced such that the upstream end portion is close to the intermediate rail 40, the displacement is restricted by abutting the pin 59 against the intermediate rail 40. As a result, the failure in engagement between the coupling pin 57 of the inner rail 50 and the coupling member 75 of the drawing mechanism 70 can be suppressed. Note that during the normal extending and retracting operation of the slide rail 11, the tip surface of the pin 59 is not in contact with the intermediate rail 40, and when the inner rail 50 is displaced so as to be close to the intermediate rail 40, the tip surface of the pin 59 is in contact with the intermediate rail 40.

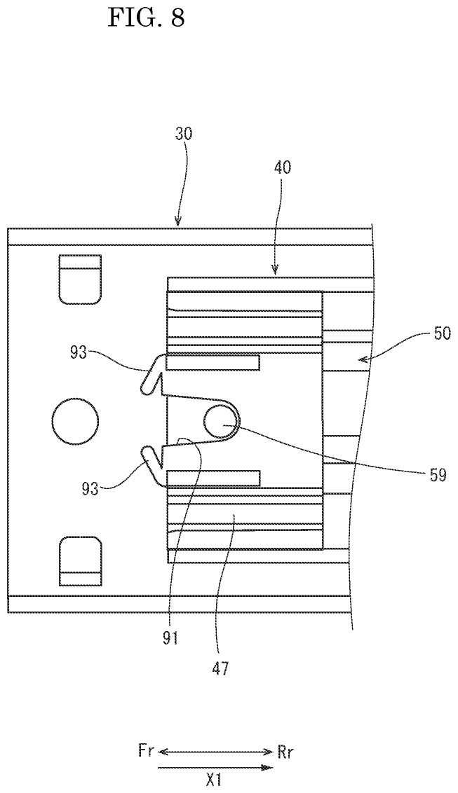

Next, a modified example of the slide rail 11 of the present disclosure will be described with reference to FIG. 8. FIG. 8 is a view showing the upstream end portion (the front end portion) of the intermediate rail 40 in the draw-in direction X1.

In the auxiliary rail 47 fixed to the upstream end portion of the intermediate rail 40 in the draw-in direction X1, a groove 91 along the draw-in direction X1 is formed from the upstream end face in the draw-in direction X1. More specifically, the groove 91 is formed along the center in the upper-and-lower direction. The width (length in the upper-and-lower direction) of the groove 91 gradually increases toward the upstream side of the draw-in direction X1. Further, the upper and lower end portions of the end surfaces of the auxiliary rail 47 are respectively provided with inclined pieces 93 inclined toward the upstream side of the draw-in direction X1.

When the slide rail 11 is retracted from the extending state to the retracting state, the pin 59 of the inner rail 50 enters the groove 91, and is guided along the groove 91 to the innermost portion. Since the groove 91 is formed widely toward the upstream side of the draw-in direction X1, the pin 59 is surely guided to the innermost portion. When the slide rail 11 is retracted from the extending state to the retracting state, the cut-out piece 61 of the inner rail 50 abuts against the inclined pieces 93 of the auxiliary rail 47.

According to this modified example, when the slide rail 11 is retracted from the extending state to the retracting state, the pin 59 of the inner rail 50 enters the innermost portion of the groove 91. Since the groove 91 is formed in the center of the intermediate rail 40 in the upper-and-lower direction, the inner rail 50 can be positioned in the upper-and-lower direction with respect to the intermediate rail 40. In addition, the rattling of the pin 59 along the upper-and-lower direction can be suppressed. Therefore, since the inner rail 50, that is, the sheet feeding cassette 9 can be positioned in an appropriate position relative to the housing 3, a clean appearance of the image forming apparatus 1 can be maintained. Further, the separation of the coupling pin 57 from the drawing mechanism 70 due to the rattling of the inner rail 50 can be suppressed.

In the above embodiments, an example of preventing the inner rail 50 from rattling by the pin 59 provided on the inner rail 50 has been described. However, since the cut-out piece 61 of the inner rail 50 also has an action to prevent the inner rail 50 from rattling, only the cut-out piece 61 may be provided in the inner rail 50.

Although the present disclosure has been described in particular embodiments, the present disclosure is not limited to the foregoing embodiments. A person skilled in the art may modify the above embodiments, so long as they do not deviate from the scope and object of the present disclosure.

1. A slide rail which supports a unit on an inner surface of a housing, the slide rail comprising:
an outer rail fixed on the inner surface of the housing;
an inner rail fixed to the unit, engaged with the outer rail and moving along the outer rail;
a drawing mechanism supported by the outer rail, coupled to the inner rail at a draw-in start position and drawing in the inner rail to a draw-in end position along a draw-in direction, wherein the inner rail includes:
a coupling pin provided on one end portion in the draw-in direction, and configured to be engaged with the drawing mechanism, and
a protrusion provided on the other end portion in the draw-in direction, and protruding toward the outer rail.

2. The slide rail according to claim 1, wherein
the outer rail has a groove in which the protrusion is inserted along the draw-in direction, and
the groove is formed such that a width is increased in an opposite direction to the draw-in direction.

3. The slide rail according to claim 1, wherein
the protrusion is a pin protruding from the inner rail or a cut-out piece formed by cutting out the inner rail

4. The slide rail according to claim 1, wherein the outer rail includes:
a fixed rail fixed on the inner side surface of the housing; and
an intermediate rail engaged with the fixed rail, engaged with the fixed rail and slid along the fixed rail, and
the drawing mechanism is fixed to the intermediate rail.

5. The slide rail according to claim 1, comprising:
a plurality of balls disposed between the outer rail and the inner rail, between the coupling pin and the protrusion in the draw-in direction.

6. The slide rail according to claim 1, wherein
the inner rail has an inclined piece to which the outer rail abuts when the unit is drawn in to the housing.

7. An image forming apparatus comprising:
the slide rail according to claim 1, wherein
the unit is a sheet feeding cassette in which a sheet on which an image is to be formed is stored, and
the draw-in end position is a sheet feeding position where the sheet can be fed from the sheet feeding cassette to an image forming part.
